(19) United States
(12) Patent Application Publication
(10) Pub. No.: US 2019/0042372 A1
(43) Pub. Date: Feb. 7, 2019

(54) METHOD AND APPARATUS TO RECOVER DATA STORED IN PERSISTENT MEMORY IN A FAILED NODE OF A COMPUTER CLUSTER

(71) Applicant: Intel Corporation, Santa Clara, CA (US)

(72) Inventors: Karthik KUMAR, Chandler, AZ (US); Francesc GUIM BERNAT, Barcelona (ES); Mark A. SCHMISSEUR, Phoenix, AZ (US); Mustafa HAJEER, Hillsboro, OR (US); Thomas WILLHALM, Sandhausen (DE)

(21) Appl. No.: 16/012,525

(22) Filed: Jun. 19, 2018

(51) Int. Cl. G06F 11/14; G06F 11/20; H04L 29/06; H04L 29/08

(52) U.S. Cl. CPC G06F 11/1464; G06F 11/2056; H04L 67/1097; G06F 11/2094; H04L 63/18; G06F 11/2043

(57) ABSTRACT

An in-memory database is mirrored in persistent memory in nodes in a computer cluster for redundancy. Data can be recovered from persistent memory in a node that is powered down through the use of out-of-band techniques.

### FIELD

This disclosure relates to persistent memory and in particular to recovery of data stored in persistent memory in a failed node of a computer cluster.

### BACKGROUND

A database is an organized collection of data. A relational database is a collection of tables, queries, and other elements. A database-management system (DBMS) is a computer software application that interacts with other computer software applications and the database to capture and analyze data.

In contrast to a traditional database system that stores data on a storage device, for example, a hard disk drive (HDD) or a Solid-State Drive (SSD), an in-memory database (IMDB) system is a database management system that stores data in main memory. An IMDB provides extremely high queries/second to support rapid decision making based on real-time analytics. The main memory may include one or more non-volatile memory devices. A non-volatile memory (NVM) device is a memory whose state is determinate even if power is interrupted to the device.

A computer cluster is a set of connected computers that work together and can be viewed as a single system. The nodes (servers) of a computer cluster are typically connected through local area networks. The in-memory database may be distributed amongst a plurality of servers in a computer cluster. A storage area network (SAN) is a high-speed network that interconnects different types of storage elements with servers and provides a shared storage pool for servers (hosts) connected to the SAN. The storage elements may include storage arrays, switches, expanders, volume managers, Host Bus Adapters (HBAs) and Redundant Arrays of Independent Disks (RAID).

To protect against potential failures, a master copy of the in-memory database stored in each server of a computer cluster may be stored in one or more storage devices in a Storage Area Network (SAN) so that if a server in the computer cluster fails, the portion of the in-memory database stored in the failed server can be recovered from the storage devices in the SAN.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a node in a computer cluster that includes an interface to allow access by at least one other node in the computer cluster to an in-memory database stored in persistent memory in the node when the node is powered down;

FIG. 2 is a block diagram illustrating the use of mirroring to provide redundancy in a computer cluster;

FIG. 3 is a block diagram illustrating hardware elements in the node shown in FIG. 1 that are used to allow access by at least one other node in the computer cluster to an in-memory database stored in persistent memory in a failed node when the failed node is powered down;

FIG. 4 is a block diagram of an embodiment of the persistent memory module 128 shown in FIG. 1;

FIG. 5 is a block diagram of the recovery data controller 306 in FIG. 4; and

FIG. 6 is a flowgraph illustrating a method to perform an out-of-band access to retrieve data stored in a persistent memory module in a failed node in a computer cluster.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

A persistent memory is a write-in-place byte addressable non-volatile memory. Each node of the computer cluster may store a portion of the in-memory database in a persistent memory. The SAN in a computer cluster in which the in-memory database is stored in persistent memory is expensive as the backup copy of the in-memory database is only used when there is a server failure and data needs to be recovered from persistent memory.

In an embodiment, instead of including a SAN in the computer cluster, an in-memory database is mirrored in persistent memory in nodes in the computer cluster for redundancy. Data can be recovered from persistent memory in a node that is powered down through the use of out-of-band techniques.

Various embodiments and aspects of the inventions will be described with reference to details discussed below, and the accompanying drawings will illustrate the various embodiments. The following description and drawings are illustrative of the invention and are not to be construed as limiting the invention Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

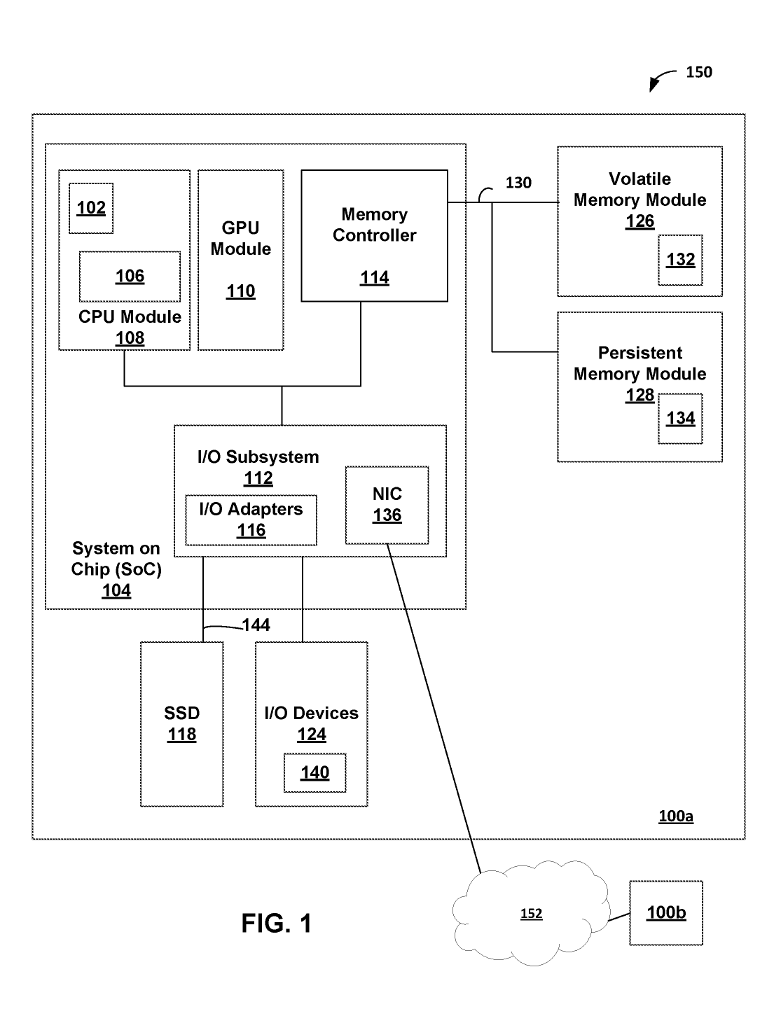

FIG. 1 is a block diagram of an embodiment of a node 100a in a computer cluster 150 that includes an interface to allow access by at least one other node 100b in the computer cluster 150 to an in-memory database stored in persistent memory in the node 100a when the node 100a is powered down.

Node 100a may correspond to a computing device including, but not limited to, a server, a workstation computer, a desktop computer, a laptop computer, and/or a tablet computer. Node 100a includes a system on chip (SOC or SoC) 104 which combines processor, graphics, memory, and Input/Output (I/O) control logic into one SoC package. The SoC 104 includes at least one Central Processing Unit (CPU) module 108, a memory controller 114, and a Graphics Processor Unit (GPU) module 110. In other embodiments, the memory controller 114 may be external to the SoC 104. The CPU module 108 includes at least one processor core 102 and a level 2 (L2) cache 106. Although not shown, the processor core 102 may internally include one or more instruction/data caches (L cache), execution units, prefetch buffers, instruction queues, branch address calculation units, instruction decoders, floating point units, retirement units, etc. The CPU module 108 may correspond to a single core or a multi-core general purpose processor, such as those provided by Intel® Corporation, according to one embodiment. In an embodiment the SoC 104 may be an Intel® Xeon® Scalable Processor (SP) or an Intel® Xeon® data center (D) SoC The memory controller 114 may be coupled to a persistent memory module 128 and a volatile memory module 126 via a memory bus 130. The persistent memory module 128 may include one or more persistent memory device(s) 134. The volatile memory module 126 may include one or more volatile memory device(s) 132.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

The I/O adapters 116 may include a Peripheral Component Interconnect Express (PCIe) adapter that is communicatively coupled using the NVMe (NVM Express) over PCIe (Peripheral Component Interconnect Express) protocol over bus 144 to a host interface in the SSD 118. Non-Volatile Memory Express (NVMe) standards define a register level interface for host software to communicate with a non-volatile memory subsystem (for example, a Solid-state Drive (SSD)) over Peripheral Component Interconnect Express (PCIe), a high-speed serial computer expansion bus. The NVM Express standards are available at www.nvmexpress.org. The PCIe standards are available at www.pcisig.com.

The Graphics Processor Unit (GPU) module 110 may include one or more GPU cores and a GPU cache which may store graphics related data for the GPU core. The GPU core may internally include one or more execution units and one or more instruction and data caches. Additionally, the Graphics Processor Unit (GPU) module 110 may contain other graphics logic units that are not shown in FIG. 1, such as one or more vertex processing units, rasterization units, media processing units, and codecs.

Within the I/O subsystem 112, one or more I/O adapter(s) 116 are present to translate a host communication protocol utilized within the processor core(s) 102 to a protocol compatible with particular I/O devices. Some of the protocols that I/O adapter(s) 116 may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The SoC 104 may include one or more network interface controllers (NIC) or Intel® Omni-Path Host Fabric Interface (HFI) adapters 136 or the NIC/HFI adapter 136 may be coupled to the SoC 104. An out-of-band access to the node 100a from another node 102b may be directed through the NIC/HFI adapters 136 in the node 100a over a network 152 while the node 100a is powered off.

The out-of-band access to the node 100a may be provided by an Intelligent Platform Management Interface (IPMI) or Intel Active Management Technology (AMT) or other technologies for out-of-band access. Intel® Active Management Technology (AMT) provides out-of-band access to remotely diagnose and repair a system after a software, operating system or hardware failure. To provide out-of-band access, AMT includes the ability to operate even when the system is powered off or the operating system is unavailable provided that the system is connected to the network and a power outlet.

The I/O adapter(s) 116 may communicate with external I/O devices 124 which may include, for example, user interface device(s) including a display and/or a touch-screen display 140, printer, keypad, keyboard, communication logic, wired and/or wireless, storage device(s) including hard disk drives (“HDD”), solid-state drives (“SSD”) 118, removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

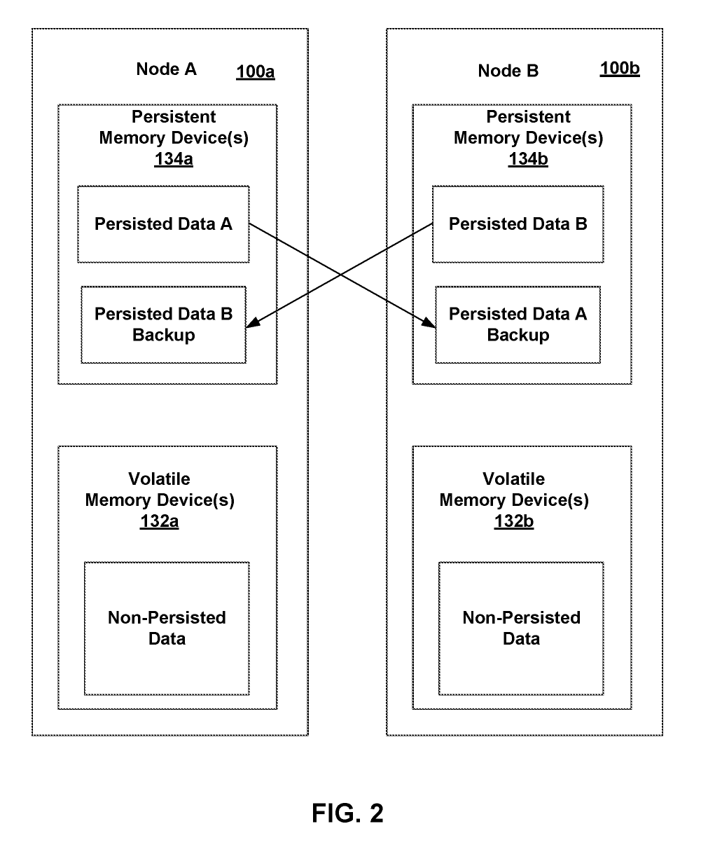

FIG. 2 is a block diagram illustrating the use of mirroring to provide redundancy in a computer cluster 150. Node A 100a and node B 100b store Persisted data A and Persisted data B, which together comprise a dataset that is used by an application in the computer cluster 150. Node A 100a and node B 100b each include respective persistent memory device(s) 134a, 134b and respective volatile memory device(s) 132a, 132b that store non-persisted data. The volatile memory device(s) may be DRAM. Persistent memory device(s) 134a, 134b provide cache-line granular access to data at DRAM-like speeds. Data stored in persistent memory device(s) 134a in node A 100a is mirrored in persistent memory device(s) 134b in node B 100b. In the example, shown in FIG. 2, data stored in persisted data A in persistent memory device(s) 134a in node A 100a is mirrored in persisted data A backup in persistent memory device(s) 134b in node B 100b and data stored in persisted data B in persistent memory device(s) 134b in node B 100b is mirrored in persisted data B backup in persistent memory device(s) 134a in node A 100a.

If node A 100a or node B 100b fails, the data can be recovered from the respective persisted data backup in persistent memory device(s) 134a, 134b in the non-failed node. However, the ability to recover data from the non-failed node 100a, 100b is not sufficient in mission critical applications in which at least two backups of the data are required. To provide an additional level of redundancy in the event that the non-failed node fails during the recovery of the mirrored data, the ability to recover data from the failed node is provided through out-of-band techniques via the NIC/HFI adapter 136.

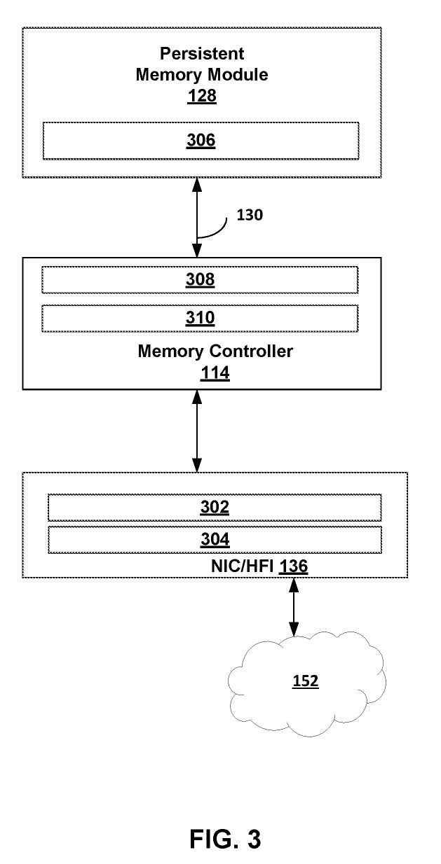

FIG. 3 is a block diagram illustrating hardware elements in the node 102a shown in FIG. 1 that are used to allow access by at least one other node in the computer cluster to an in-memory database stored in persistent memory 128 in a failed node when the failed node is powered down.

Data stored in the persistent memory module 128 in a failed node can be retrieved via an out of band access through the NIC/HFI interface 136 if the NIC/HFI 136, memory controller 114 and persistent memory module 125 and the on-die interconnect between the NIC/HFI 136, memory controller 114 and persistent memory module 125 are functional. A request to read data stored in the persistent memory module 128 in the failed node is received by the NIC/HFI 136 from a requester node. The NIC 136 sends the received request to the memory controller 114. The memory controller 114 accesses the requested data stored in the persistent memory module 128 and returns the requested data to the NIC/HFI 136 to return to the requester node.

The NIC/HFI 136 includes Out of Band Recovery Authorization circuitry 304 and Out of band Recovery circuitry 302 in the HFI or NIC block in FIG. 3. The nodes that can access data stored in the persistent memory module 128 are privileged nodes that have access to the out of band (OOB) network. The Out of Band Recovery Authorization circuitry 304 ensures that the requesting node has sufficient privileges to access the failed node.

The Out of band Recovery circuitry 302 allows other nodes in the computer cluster to access the data in the persistent memory module 128. Two types of data access interfaces are provided.

The first data access interface is a Remote Direct Memory Access (RDMA) based interface to perform a load at an address in the persistent memory module 128 in response to an Application Programming Interface (API) command (RDMARecoveryLd (@address)) to load data from the specified “address” in the persistent memory module.

The second data access interface allows access to specific memory lines for specific ranks and persistent memory modules. Data stored in a persistent memory module is read in response to an API command (RecoveryLd (memory module ID, RANK, #line)). The memory module Identifier (ID) identifies the memory module, the RANK identifies and #line identifies the cache line within the RANK. A memory rank is a set of memory chips that are accessed simultaneously via the same chip select. Multiple ranks can coexist on a single memory module.

In an embodiment in which the SoC 104 is one of a plurality of SoCs 104 in a scalable multiprocessor system with a shared address space, the memory controller 114 includes a point-to-point processor interconnect, for example, Intel® UltraPath Interconnect (UPI), Intel® QuickPath Interconnect (QPI) or any other point-to-point processor interconnect.

Intel® UPI is a coherent interconnect for scalable systems containing multiple processors in a single shared address space. processors (for example, Intel® Xeon®) that support Intel UPI, provide either two or three UPI links for connecting to other processors using a high-speed, low-latency path to the other processors.

UPI extension circuitry 308 in the memory controller 114 allows the propagation of the APIs to access data in the Persistent Memory Module 128 from the HFI or NIC 136 through the UPI bypassing a caching agent in the UPI interface. Extended request circuitry 310 in the memory controller 114 allows access to the data stored in the persistent memory module 128.

The extended request circuitry 310 in the memory controller 114 accesses the requested data line in the rank in the memory module specified in the API and returns the data line to the HFI/NIC 136. In response to the RDMARecoveryLd (@address)) API command, the extended request circuitry 310 returns the data stored in the data line. In response to the RecoveryLd (memory module ID, RANK, #line) API command, the extended request circuitry 310 returns the data stored in the data line and the metadata associated with the data. The metadata may include Error Correction Count (ECC) and current write count.

In an embodiment, one cache line, that is, 64 bytes can be read per access from the persistent memory module 128. If more than 64 bytes is requested, for example, the data request received by the NIC 136 from the requester node is for 1 Mega Byte (MB)), multiple 64 byte accesses may be performed to fetch the requested data.

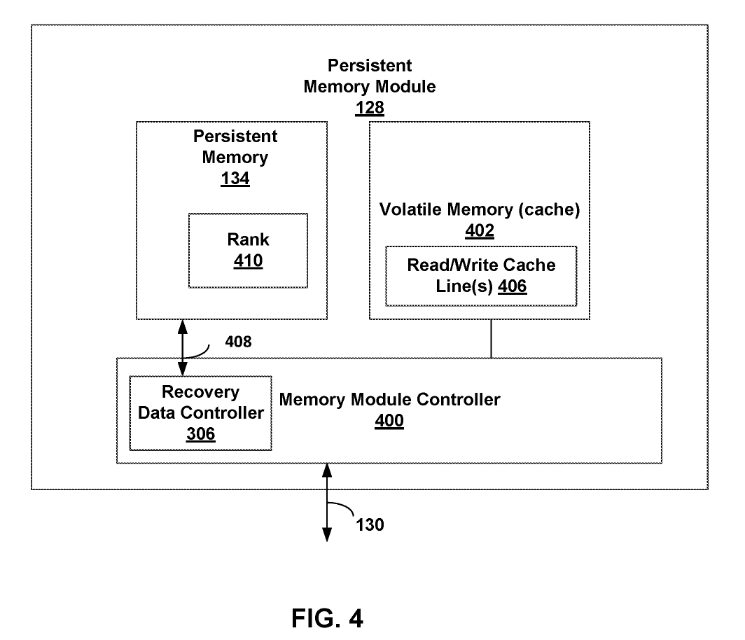

FIG. 4 is a block diagram of an embodiment of the persistent memory module 128 shown in FIG. 1. In an embodiment, the persistent memory module 128 is mechanically and electrically compatible with JEDEC DDR4 (DDR version 4, initial specification published in September 2012 by JEDEC). DDR4 memory modules transfer data on a data bus that is 8 bytes (64 data bits) wide. The persistent memory module 128 may be a dual-in-line memory module (DIMM), that is, a packaging arrangement of memory devices on a socketable substrate. The DIMM may include one or more ranks (a set of memory devices that share the same chip select) 410.

The persistent memory module 128 includes a byte-addressable write-in-place non-volatile memory that may be referred to as a persistent memory 134. In the embodiment shown in FIG. 1, the persistent memory module 128 is directly addressable by a CPU module 108 in the SoC 104 via the memory bus 130. Data stored in the persistent memory 134 in the persistent memory module 128 is available after a power cycle.

The persistent memory module 128 also includes a volatile memory 402 which acts as a cache for the persistent memory 134 which may be referred to as cache memory. Data is transferred between persistent memory 134 and volatile memory 402 (which may be referred to as an intra-module transfer) in blocks of fixed size, called cache lines or cache blocks.

M times N-bytes of data are transferred between persistent memory 134 and cache memory 202 for a single transfer (for example, each read/write access) on the persistent memory module 128. For example, M may be 2 or 4. In an embodiment in which N is 64-bytes and M is 4,256-bytes are transferred for each transfer between persistent memory 134 and cache memory 202. In other embodiments, more than 256 bytes may be transferred per single transfer between persistent memory 134 and cache memory 202, for example, 512 bytes or 4 Kilobytes (KB). When writing a cache line from cache memory 402 to persistent memory 134, the memory module controller 400 merges 64-byte cache lines in the cache memory 402 to perform a single write access to write 256 bytes to the persistent memory 134.

Each cache line in the volatile memory 402 stores N-bytes of data which is the same as the number of bits of data transferred over memory bus 130 for a single transfer (for example, read/write access) between the memory controller 114 and the persistent memory module 128. The memory module controller 400 fetches data from persistent memory 134 and writes the data to the cache memory 402. M times N-bytes of data is transferred between persistent memory 134 and cache memory 402 for a single transfer (for example, each read/write access) on the persistent memory module 128. For example, M may be 2 or 4. In an embodiment in which N is 64-bytes and M is 4, 256-bytes are transferred for each transfer between persistent memory 134 and cache memory 202. In other embodiments, more than 256 bytes may be transferred per single transfer between persistent memory 134 and cache memory 202, for example, 512 bytes or 4 Kilobytes (KB). When writing a cache line from cache memory 402 to persistent memory 134, the memory module controller 400 merges 64-byte cache lines in the cache memory 402 to perform a single write access to write 256 bytes to the persistent memory 134.

The memory module controller 400 includes recovery data access data path controller 306 that provides access to data stored in the persistent memory module 128 in response to an out-of-band request to read the data stored in the line. As described earlier in conjunction with FIG. 3, the raw data (both user data and meta-data) stored in the persistent memory module 128 may be returned in response to the request to read the data from the persistent memory module 128. The received API commands RDMARecoveryLd (@address) and RecoveryLd (memory module ID, RANK, #line) are translated to API commands GetRawData (@address) or GetRawData (memory module ID, RANK, #line) to retrieve the data stored in the persistent memory module.

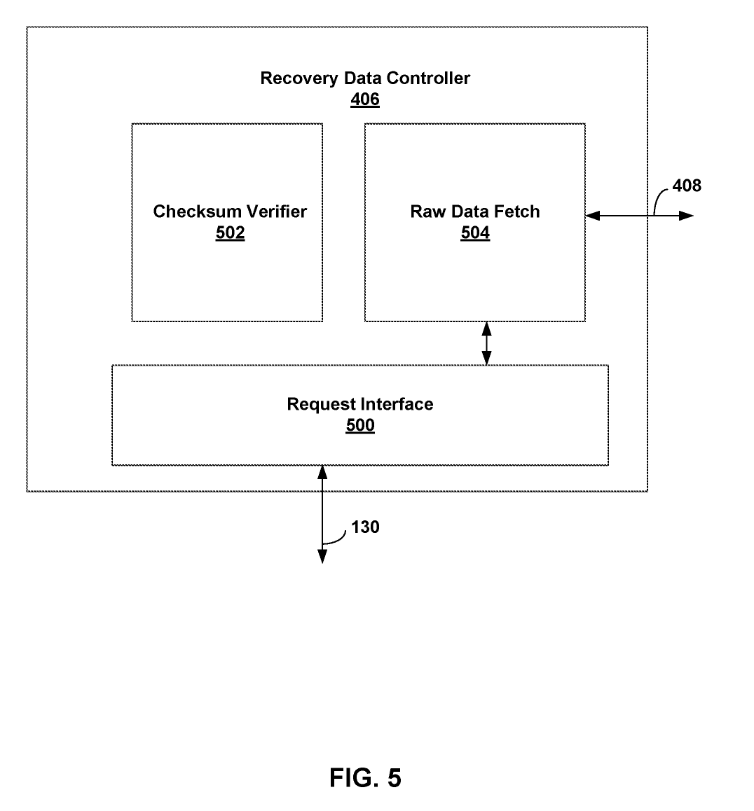

FIG. 5 is a block diagram of the recovery data controller 306 in FIG. 4. The recovery data controller 306 includes a request interface 500, checksum verifier 502 and raw data fetch 504. The request interface 500 is the interface through which a request is made to fetch data.

The checksum verifier 502 verifies integrity of the data before it is transmitted. The verification of the data may be performed using a checksum algorithm.

Raw data fetch 504 is circuitry that converts an application level request for data to a set of bits for transfer. The conversion of the request includes retrieving the layout and organization of data stored in the persistent memory module 126 when the node is powered on or powered down. For example, data may be interleaved or striped across multiple memory modules or ranks within a memory module.

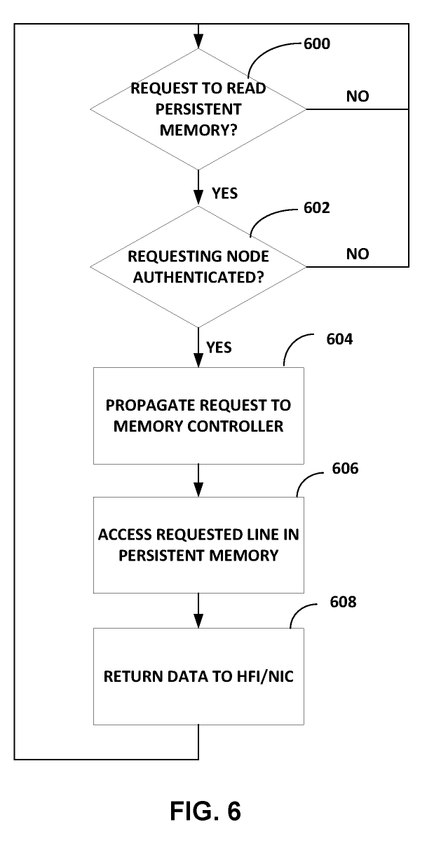

FIG. 6 is a flowgraph illustrating a method to perform an out-of-band access to retrieve data stored in a persistent memory module in a failed node in a computer cluster.

At block 600, if the HFI/NIC 136 receives an API instruction via request interface 500 from a requesting node in the computer cluster 100 to access data stored in the persistent memory 134, processing continues with block 602. If not, processing continues with block 600.

At block 602, if the Out of Band Recovery Authorization circuitry 304 in the HFI/NIC 136 authenticates the requesting node, processing continues with block 604. If not, processing continues with block 600.

At block 604, the HFI/NIC 136 propagates the API instruction to the memory controller 114, processing continues with block 606.

At block 606, the memory controller 114 accesses the requested line in the persistent memory 134 in the persistent memory module 128 and reads the data stored in the requested line. Processing continues with block 608.

At block 608, the memory controller 114 returns the data read from the requested line in the persistent memory 134 to the HFI/NIC 136. Processing continues with block 600.

An embodiment has been described for a computer cluster 100 with an in-memory database. In other embodiments the computer cluster 100 may include a NoSQL database or scale out big data applications.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
a network interface communicatively coupled to a memory controller and to a network, the network interface to process an out-of-band read request received from a node communicatively coupled to the network to read data stored in persistent memory in a persistent memory module communicatively coupled to the memory controller, the network interface to authenticate the node, forward the out-of-band read request to the memory controller and to return the data read from the persistent memory module to the node.

2. The apparatus of claim 1, wherein the out-of-band read request includes an address for the out-of-band read request in the persistent memory module.

3. The apparatus of claim 1, wherein the out-of-band read request includes an identifier for the persistent memory module, a rank within the persistent memory module and a line identifier within the rank.

4. The apparatus of claim 1, wherein the out-of-band read request to persistent memory module returns 64 bytes.

5. The apparatus of claim 1, wherein the read data includes metadata.

6. The apparatus of claim 5, wherein the metadata includes an Error Correction Code.

7. The apparatus of claim 1, wherein the network interface is an Omni-Path Host Fabric Interface.

8. The apparatus of claim 1, wherein the read data is a portion of an in-memory database.

9. A method comprising:
processing, by a network interface, an out-of-band read request to read data stored in a persistent memory in a persistent memory module received from a node communicatively coupled to a network, processing further comprising;
authenticating the node;
forwarding the out-of-band read request to a persistent memory controller to read data stored in the persistent memory; and
returning data read from the persistent memory to the node.

10. The method of claim 9, wherein the out-of-band read request includes an address for the out-of-band read request in the persistent memory module.

11. The method of claim 9, wherein the out-of-band read request includes an identifier for the persistent memory module, a rank within the persistent memory module and a line identifier within the rank.

12. The method of claim 9, wherein the out-of-band read request to the persistent memory module returns 64 bytes.

13. The method of claim 9, wherein data read from the persistent memory includes metadata.

14. The method of claim 13, wherein the metadata includes an Error Correction Code.

15. The method of claim 9, wherein the network interface is an Omni-Path Host Fabric Interface.

16. The method of claim 9, wherein data read from the persistent memory module is a portion of an in-memory database.

17. A system comprising:
a persistent memory module;
a memory controller communicatively coupled to the persistent memory module to read data stored in the persistent memory module;
a network interface communicatively coupled to the memory controller and to a network, the network interface to process an out-of-band read request received from a node communicatively coupled to the network to read data stored in persistent memory in the persistent memory module, the network interface to authenticate the node, forward the out-of-band read request to the memory controller and to return the data read from the persistent memory module to the node; and
a processor communicatively coupled to the network interface.

18. The system of claim 17, wherein the out-of-band read request includes an address for the out-of-band read request in the persistent memory module.

19. The system of claim 18, wherein the out-of-band read request includes an identifier for the persistent memory module, a rank within the persistent memory module and a line identifier within the rank.

20. The system of claim 19, wherein data read from the persistent memory module is a portion of an in-memory database.
